(19) United States
(12) Patent Application Publication
(10) Pub. No.: US 2014/0101067 A1
(43) Pub. Date: Apr. 10, 2014

(54) SYSTEMS AND METHODS FOR WELLNESS PROGRAMS

(71) Applicants: Rick Stollmeyer, San Luis Obispo, CA (US); Chet Brandenburg, Grover Beach, CA (US)

(72) Inventors: Rick Stollmeyer, San Luis Obispo, CA (US); Chet Brandenburg, Grover Beach, CA (US)

(73) Assignee: MINDBODY, Inc., San Luis Obispo, CA (US)

(21) Appl. No.: 13/691,401

(22) Filed: Nov. 30, 2012

Related U.S. Application Data
(60) Provisional application No. 61/711,057, filed on Oct. 8, 2012.

(51) Int. Cl. G06Q 10/10

(52) U.S. Cl. CPC G06Q 10/1057
USPC 705/322

(57) ABSTRACT

One example embodiment relates to a method that comprises receiving a listing of wellness providers from a wellness program operator, the listing identifying wellness providers each offering a wellness service and being located within a region geographically proximate to a predetermined geo-location; authorizing a subset of the wellness providers to form part of an employee health benefit program; and presenting the subset of authorized wellness providers to an employee.

### CLAIM OF PRIORITY

This patent application claims the benefit of priority, under 35 U.S.C. Section 119(e), to Stollmeyer et al, U.S. Provisional Patent Application Ser. No. 61/711,057, entitled “Systems and Methods for Wellness Programs” filed on Oct. 8, 2012 (Attorney Docket No. 3717.002PRV), which is hereby incorporated by reference herein in its entirety.

### FIELD

This application relates generally to managed wellness programs, and more specifically to managed wellness systems allowing in some embodiments employee incentives and reduced medical costs and associated insurance premiums.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2012, MINDBODY, INC., all Rights Reserved.

### BACKGROUND

Employers sometimes provide their employees with rewards or bonuses as part of a comprehensive benefits package and to encourage desirable behavior. Part of a benefits package can include medical benefits, for example membership with a medical insurance provider and support in paying premiums. Employee medical costs can have a significant effect on corporate finances.

### SUMMARY

Enlisting employees as active participants in their own health or wellness can increase employee satisfaction and the quality of the health experience while decreasing the cost of providing that care. Patient satisfaction can be dramatically improved by providing greater control and easier access for the patient to request and schedule appointments for medical care and wellness services. Allowing greater control and facilitating the selection of health or wellness service providers by employers can allow an employer to provide employee incentives and reduce costs. Mutual benefits can thus include increased participation by employees in taking care of their own health and wellness, while reducing medical costs for employers and lowering related health insurance premiums.

In an example embodiment, a system for a wellness program comprises at least one module, executing on one or more computer processors, to present a listing of wellness providers to an employer, the listing identifying wellness providers each offering a wellness service and being located within a region geographically proximate to a geo-location of the employer or an employee of the employer; receive a subset of the wellness providers authorized by the employer to form part of an employer wellness program; and present the subset of authorized wellness providers to the employee and to at least one authorized wellness provider.

In another example embodiment, a machine readable medium for a wellness program includes instructions, which when performed by a machine, cause the machine to perform the operations of presenting a listing of wellness providers to an employer, the listing identifying wellness providers each offering a wellness service and being located within a region geographically proximate to a geo-location of the employer or an employee of the employer; receiving a subset of the wellness providers authorized by the employer to form part of an employer wellness program; and presenting the subset of authorized wellness providers to the employee and to at least one authorized wellness provider.

In an example embodiment, a system comprises at least one module, executing on one or more computer processors, to present a listing of wellness providers to an employer, the listing identifying wellness providers located within a region geographically proximate to a geo-location of the employer, or an employee of the employer; receive a subset of the wellness providers authorized by the employer to form part of an employer wellness program, the wellness program including incentives for employee use of a service provided by one or more of the authorized wellness providers; and present the subset of authorized wellness providers to employees and to at least one authorized wellness provider.

In another example embodiment, a machine readable medium includes instructions, which when performed by a machine, cause the machine to perform the operations of presenting a listing of wellness providers to an employer, the listing identifying wellness providers located within a region geographically proximate to a geo-location of the employer, or of an employee of the employer; receiving a subset of the wellness providers authorized by the employer to form part of an employer wellness program, the wellness program including incentives for employee use of a service provided by one or more of the authorized wellness providers; and presenting the subset of authorized wellness providers to employees and to at least one authorized wellness provider.

In an example embodiment, a system comprises at least one module, executing on one or more computer processors, to present a listing of wellness providers to an employer, the listing identifying wellness providers located within a region geographically proximate to a geo-location of the employer, or an employee of the employer; receive a subset of the wellness providers authorized by the employer to form part of an employer wellness program, the wellness program including incentives for employee use of a service provided by one or more of the authorized wellness providers; and present the subset of authorized wellness providers to employees and to at least one authorized wellness provider.

In another example embodiment, a machine readable medium includes instructions, which when performed by a machine, cause the machine to perform the operations of presenting a listing of wellness providers to an employer, the listing identifying wellness providers located within a region geographically proximate to a geo-location of the employer, or of an employee of the employer; receiving a subset of the wellness providers authorized by the employer to form part of an employer wellness program, the wellness program including incentives for employee use of a service provided by one or more of the authorized wellness providers; and presenting the subset of authorized wellness providers to employees and to at least one authorized wellness provider.

### BRIEF DESCRIPTION OF DRAWINGS

Embodiments are illustrated by way of example and not limitation in the figures of the accompanying drawings. Like reference numbers indicate similar elements.

FIG. 1 is a block diagram illustrating aspects of a wellness program, according to example embodiments.

FIG. 2 is an overview of the architecture and functioning of the wellness program software, according to example embodiments.

FIGS. 3A-3G show screenshots depicting aspects of the wellness program, according to example embodiments.

FIGS. 4A-4C illustrate in block outline some operations of example methods for a wellness program, in accordance with example embodiments.

FIG. 5 is a diagrammatic representation illustrating an example machine in the form of a computer system within which a set of instructions for causing the machine to perform a portion of any one or more of the methodologies discussed herein may be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments may be combined, other embodiments may be utilized, or structural, logical and electrical changes may be made without departing from the scope of what is claimed. The following detailed description is, therefore, not to be taken in a limiting sense.

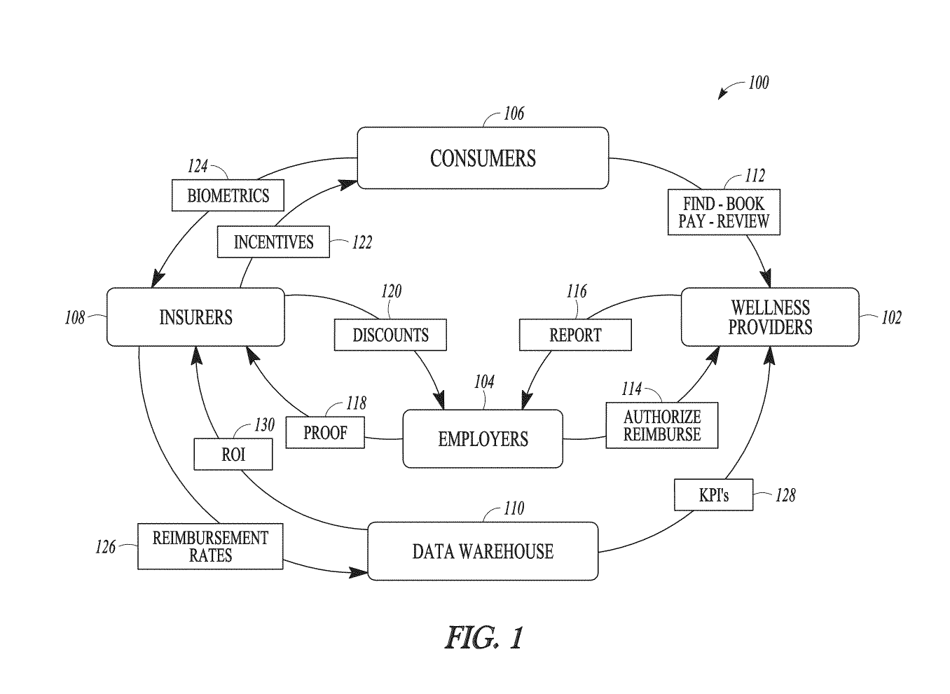

Some example embodiments of systems and methods for wellness programs are described herein. In this specification, the terms “wellness” and “health” are used interchangeably. Reference is now made to FIG. 1 of the accompanying drawings. This view depicts a schematic block diagram providing an overview of a wellness program 100 according to the present subject matter. The wellness program includes wellness providers 102, employers 104, consumers 106, wellness or health insurers 108, and a data warehouse (or database) 110. The consumers 106 can include employees of an employer 104. The database 110 will typically be created and owned by a program operator, such as MindBody Inc.

Viewed broadly, the wellness providers block 102 represents a body of wellness providers and an aggregate of information including available classes, appointments, schedules, price points and other information relating to or offered by wellness service providers. The wellness providers 102 can also be referred to as clients within the program. The aggregate of information about the wellness providers 102 can be stored in the database 110 which is described in more detail below.

The consumers represented by block 106 can use the aggregated information represented by block 102 to find the wellness providers 102 and related services they want to use. In some embodiments, the wellness providers 102 are identified based on their geo-location near the premises of an employer 104. The consumers 106 can book and pay for services offered by the wellness providers 102 and, after the services have been received, review the services. These actions are represented by block 112 in FIG. 1.

Employers, represented by block 104, are becoming increasingly concerned about medical costs. In some instances, an employer 104 will pay for insurance costs and premiums for health insurance provided by the insurers 108. In order to help mitigate some of these costs, the wellness program 100 can be presented to and used by employers 104, wellness providers 102, consumers 106, and insurers 108 in the following manner.

A list of wellness providers 102 located within a geographic region around or near to a location of the employer 104 is presented to the employer 104. In order to locate these services, the employer 104 can be referred to a website (for example, mindbodyfinder.com, or a mobile interface in a portable electronic device such as a smart phone, of iPhone for example) and, using a zip code for example, identify a list of wellness service providers 102 located within their area. In some instances, hundreds of wellness providers might be identified within a few miles of the employer's location.

The employer 104, perhaps represented by an HR director of other officer, can select which of these identified services the employer 104 authorizes as company-approved service providers 102 for their employees 106 to use as part of the wellness program 100. The selection may be associated with an incentive which may include a cost-sharing arrangement, for example. The employer 104 might offer to pay on behalf of an employee all or half of the costs of the wellness provider 102, for example. Alternatively, the employer 104 might offer to pay a fixed amount, for example, the first two hundred dollars of the wellness provider's costs. The authorization and reimbursement of such costs is represented by block 114 in FIG. 1.

A wellness provider in block 102 delivers the services, documents the use of the services by the employee, and reports the employee's use of the services to the employer 104. The documentation and reporting action is represented by block 116 in FIG. 1. In some embodiments, an employer 104 will provide a list of approved employees 106 to a given wellness provider 102, and in some instances an employee 106 will in turn need to present evidence to that wellness provider 102 to identify themselves as an authorized, current employee 106 of the employer 104. The subset of authorized wellness providers and, where applicable, the incentive or reimbursement arrangement between the employer and employee, can be communicated to the employees 106 and to the relevant wellness providers 102. The communication might be effected, for example, by a communications module within a computer system 500 described further below.

In some examples there may be negotiation and agreement on an appropriate reimbursement or co-pay rate to be provided to the wellness provider 102, depending on the incentive arrangement offered to or agreed with the employees 106. A reimbursement, shown at block 114, to a service provider 102 by an employer 104 may be made in response to receipt by the employer of the report 116.

The wellness program 100 can include health insurance companies. These are represented by block 108. A health insurer 106 can for example work with an employer 104 such that lower insurance premiums are proactively offered to employees 106 in response to the employer 104 engaging its employees in the wellness program 100. The day-to-day operation of such an arrangement is represented by proof-of-participation block 118 and discounts block 120. Information or data forming part of the reports represented by block 116 may also form part of the proof to insurers indicated at block 118.

Other incentives can independently be offered by the insurers 106 to the employees 106 as represented by incentives block 122. The incentives may be offered in response to receipt, for example, of biometric information 124 provided by the employees 106. The provision of proof-of-participation 118 to the insurers 106 can be facilitated by the information contained in the database represented by the data warehouse block 110. This database 110 can include the wellness activities of the employees 106 and the activities of the wellness providers 102 in delivering their services. The database can also store the relevant reimbursement rates present within the program 100 at block 126, and appropriate key performance indicators of wellness providers at KPI block 128.

The database 110 may be composed of one or more logical or physical databases. For example, the database may be viewed as a system of databases, or implemented as a relational database, a centralized database, a distributed database, an object oriented database, or a flat database in various embodiments. Data stored in a first database may be associated with data in a second database through the use of common data fields.

An employer 104 within the program 100 can receive documentation that its employees 106 are participating in the program 100 and using the services of a wellness provider 102. On the basis of such participation, the health insurers 106 can discount their insurance rates accordingly. The insurers 106 are able to justify this reduction because they have proof of return-on-investment shown at ROI block 130. Return-on-investment (ROI) can include sales increases and expense (medical cost) reductions, for example. This proof is typically provided by a wellness program operator (such as MindBody Inc.) using the information contained in the database 110.

The wellness program 100 can also include the following entities and definitions which can be used interchangeably, where appropriate, with the terms used with reference to FIG. 1 to describe employers 104, wellness providers 102, consumers 106, and insurers 108.

Accordingly, one aspect of the program 100 can include a “wellness service” offered by the program operator, such as MindBody Inc. This service is a class or appointment based service that is believed to improve the health and wellness of people (for example, the consumers 106 in FIG. 1), thereby minimizing their healthcare costs and maximizing their quality of life and productivity. Examples of wellness services can include yoga, pilates, spinning, Zumba and similar group exercise classes, personal training, sports activities, massage and other spa treatments, meditation, nutrition counseling, as well as “alternative medicine” practices such as ayurveda, acupuncture and Chinese medicine.

A “covered individual” can include an individual (for example, a consumer or employee 106 in FIG. 1) whose wellness services are reimbursed in whole or in part by a “participating payer”. A “participating payer” can include an employer, individual or government agency (for example, an employer shown at block 104 in FIG. 1) who and has agreed to pay for a portion of a covered individual's approved wellness services. Typically, this entity is also responsible for paying all or a portion of a covered individual's healthcare costs, and is hence motivated to reduce those costs. A “participating insurer” can include an insurance company (for example, an insurer 106 in FIG. 1) that has agreed to give cost incentives to participating payers in return for documented participation by a covered individual in the wellness program 100.

A “participating provider” can include an individual or company (for example, a wellness provider at block 102 in FIG. 1) involved in the business of providing wellness services and who participates in the program 100. Participation in the program by the participating provider can for example include subscription to web-based business management software offered by the program operator.

An “online appointment” within the program 100 can include a covered individual's commitment to receive a 1:1 wellness service at a particular date, time and place. An example of an online appointment can include a personal training appointment at a participating provider's downtown location. An “online reservation” within the program 100 can include a covered individual's commitment to attend a class-based wellness service at a wellness provider 102. The reservation can be made, for example, via an internet-connected device in advance of the class start time. An example of an online reservation can include a reservation to participate in a regularly scheduled yoga or group exercise class.

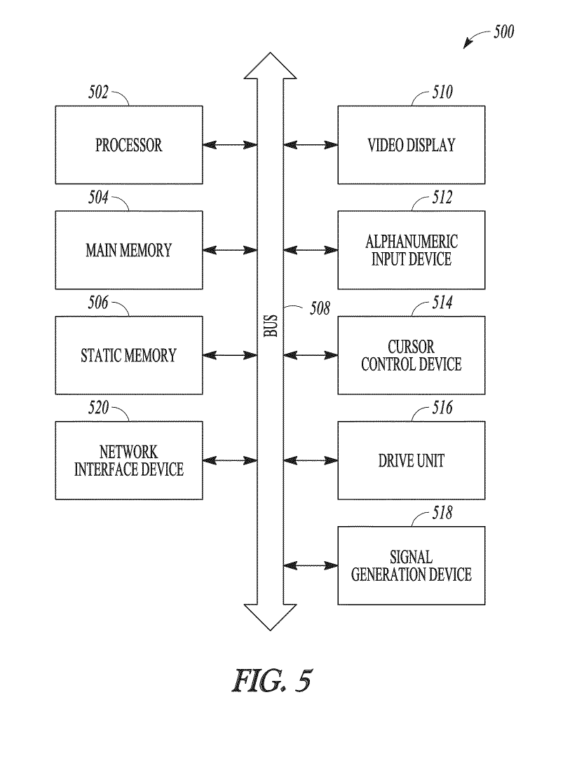

In an example embodiment, a wellness system is provided to implement the wellness program 100. The wellness system can include components of the system 500 described in more detail below with reference to FIG. 5. In an example embodiment, the wellness system includes an aggregate database, such as the database 110 illustrated in FIG. 1. The aggregated database may include a proprietary database in which a continually updated record of all participating providers 102 and participating payers 104 is maintained, together with their geo-location, the wellness services offered by wellness providers 102, covered individual wellness services received, fees incurred, payments made, and so forth. Any of the information relating to the entities, actions and blocks 102-130 described with reference to FIG. 1 may be stored in the database 110.

The wellness system can include software implementing on processors to provide user interfaces, dashboards, and mobile device wellness applications. Using the definitions set out above, one aspect of the software can include business management software that can present an interface to a participating provider, for example a wellness provider represented by block 102 in FIG. 1. In some embodiments, the business management software provides real-time aggregation of participating provider information in a web accessible database 110. The software also enables online appointments and online reservations to be made from participating provider websites and via mobile device applications, for example.

Participating providers 102 using the system can rapidly check-in, confirm participating payer 104 authorization, calculate covered individual 106 cost share and conduct any split payment transactions or reimbursements 114 that have been set up as part of an employer incentive scheme, for example. The software can provide covered individual accountability, with positive confirmation that a wellness service was actually completed by such an individual. Specific information about the wellness service completed (for example, hours on a tread mill, laps in a pool) can be provided. The software also enables electronic aggregation and submission of approved reimbursements to participating providers 102 for completed wellness services. In an example embodiment, the software enables reconciliation of participating payer electronic reimbursements. The software can also report on ROI from overall participation by the various users 104 and 106 participating in the wellness program 100. It will be appreciated that other features and enhancements of the software can be provided.

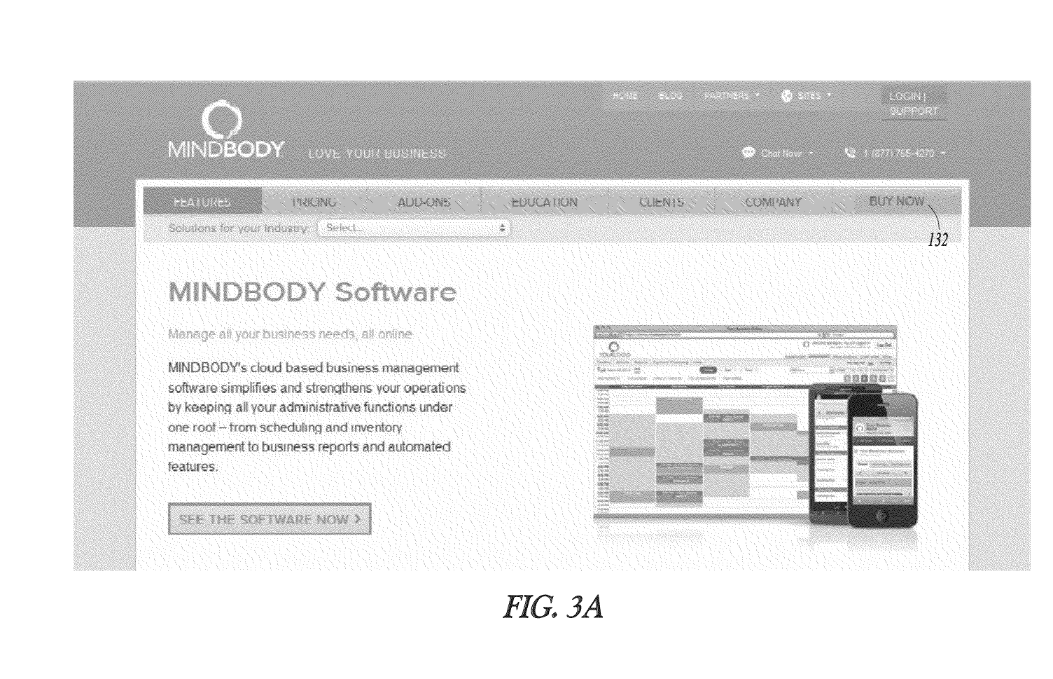

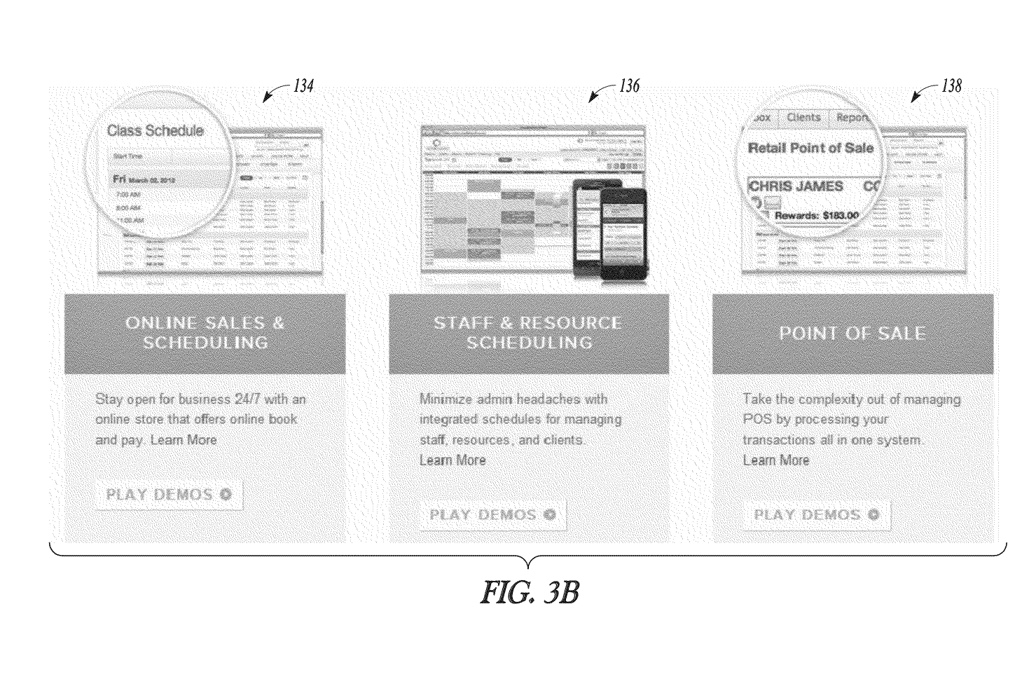

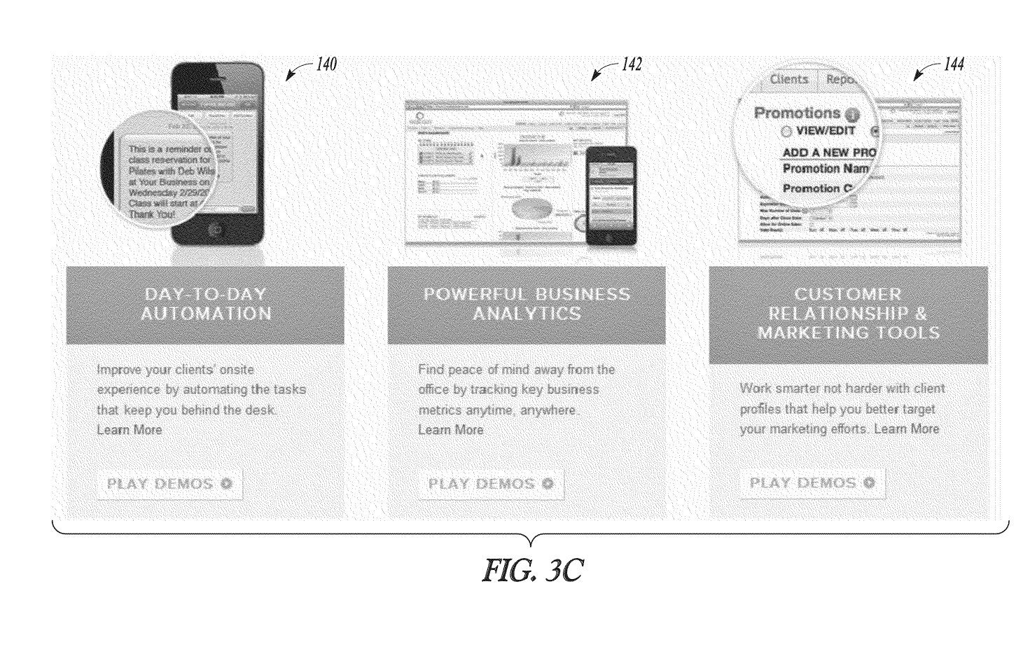

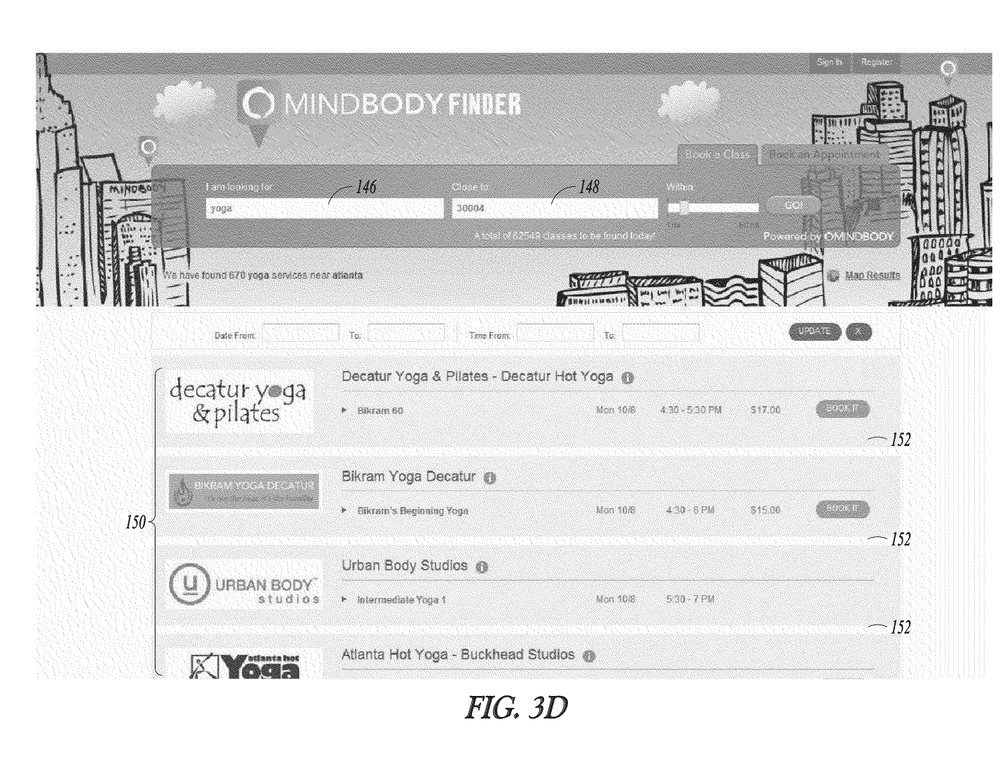

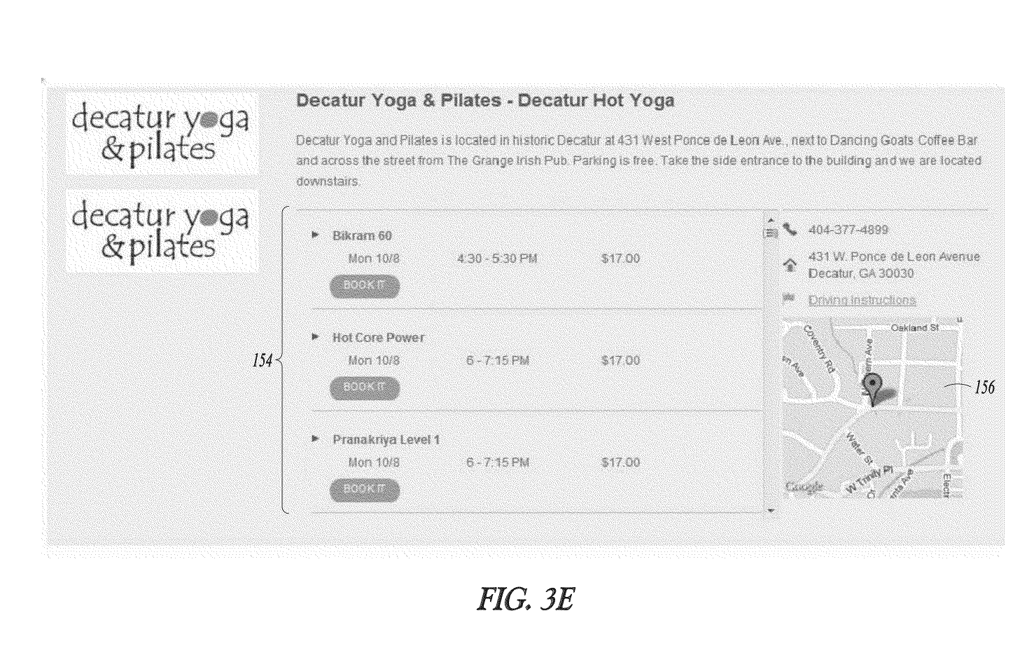

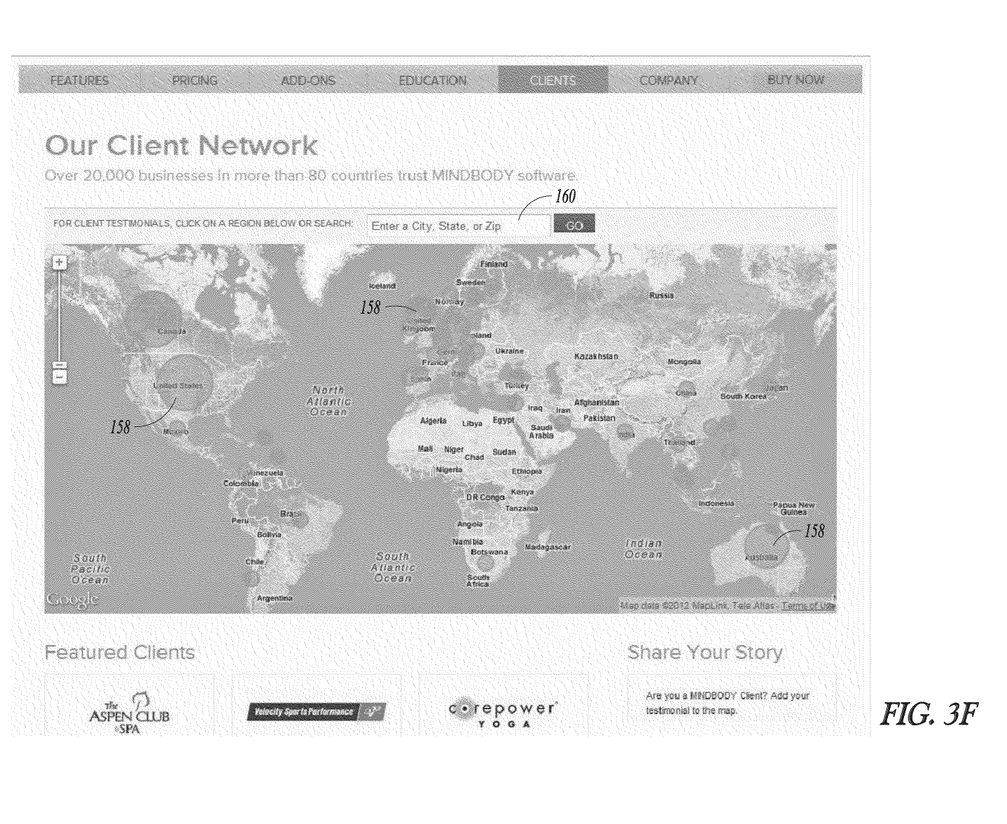

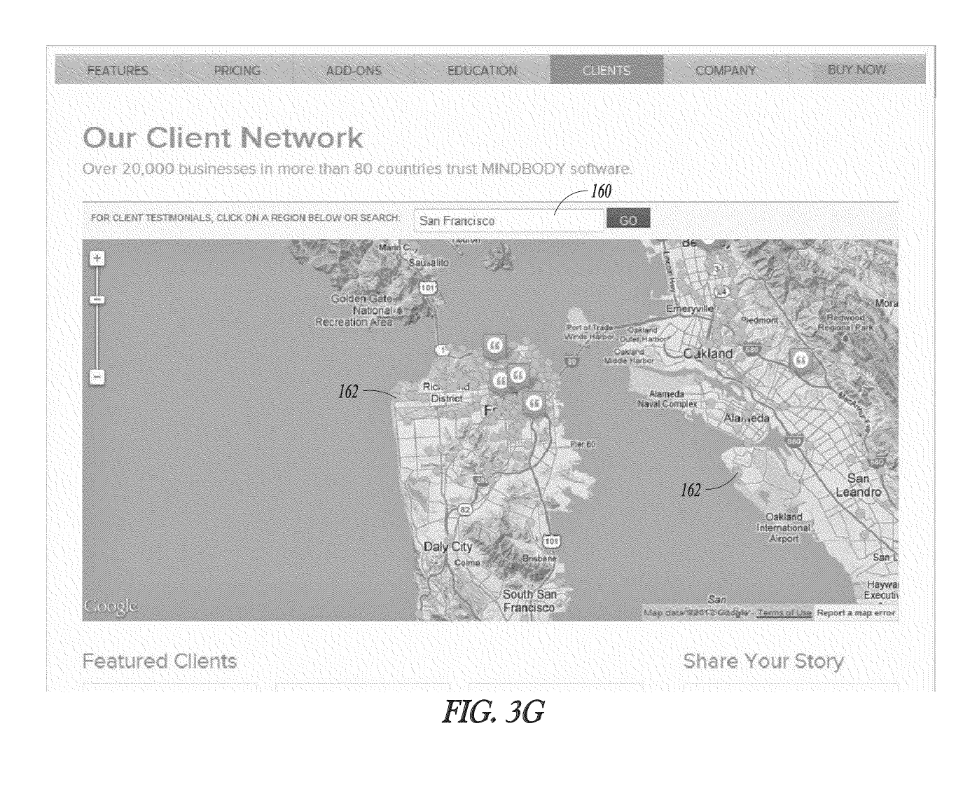

The wellness system can further include a “corporate wellness” dashboard as another example user interface. The dashboard might comprise one or more of the views depicted in the screenshots of FIGS. 3A-3C described further below. A typical user of a dashboard might be an HR officer, or an accounts or finance manager at a participating payer 104. The functionality of the dashboard enables a participating payer 104 to review geo-located services offered in the vicinity of an employer office location or an employee home. The dashboard further enables participating payers 104 to authorize or de-authorize a sub-set of identified wellness providers 102 as approved participants in a corporate wellness program 100. Categories of services or participating providers 102 can be authorized or de-authorized individually or en masse. In an example embodiment of the program 100, a business corporation might, as a participating payer, offer an incentive to its employees and communicate the statement that “Our company will reimburse employees for fitness classes but not massage therapy”. The communication could be made by or routed through the program operator using, for example, a communications module in the wellness system. In an example embodiment, the functionality of the dashboard interface also enables participating payers to designate their cost shares and co-payments. For example, a participating payer might incentivize its employees as follows: “Our company will pay 50% of your monthly wellness costs up to first $200”. The dashboard can also enable a participating payer to upload and continually update a list of employees identified as covered individuals. The list can for example include employee names, email addresses, cell phone and employee ID numbers.

The system enabling the wellness program 100 may further include wellness applications for smart phones, mobile devices and the like. An application will typically present an interface to a user, for example a covered individual 106 for example. The application interface may include co-branding to suit a given participating payer 104. For example, a logo or action element presented in the interface of the mobile application may indicate “Ajax Corporation Wellness App”. The mobile application can be used by a covered individual 106 to quickly find available wellness services from authorized participating providers 102 based on geo-location, for example. The application also enables a covered individual to make online appointments and online reservations, using their employee ID as a payment credential, for example. The mobile applications further enable a covered individual to track his or her on-going wellness performance and goals. This information might for example form part of the reporting action at block 116 or the biometric data provision represented by block 124 in FIG. 1.

The wellness program 100 and the system supporting it can provide the following functionality and advantages. Participating payers 104 and covered individuals 106 can conveniently identify which wellness services and providers 102 are management software linked to an aggregate database which automatically aggregates information such as the service types, descriptions, prices and schedules of participating providers in the course of their daily business operations. A key feature is that no (or very minimal) ongoing actions are required by participating providers to offer their wellness services to covered individuals and receive participating payer reimbursement. This can facilitate marketability and efficacy of the wellness program 100 and the system enabling it. These and other aspects and tools of the wellness program can be provided via a website, such as www.mindbodyfinder.com, and presented as part of a corporate wellness program or employer communication.

The wellness program 100 allows participating payers to quickly authorize and de-authorize potentially thousands of participating providers 102 and categories of services offered by the wellness providers 102 en masse for their authorized employees as covered individuals. Participating payers can receive positive confirmation that the covered individual actually completed the wellness service. This can provide increased personal accountability in employer wellness programs. Participating payers 102 and participating insurers 108 can access aggregated data that establishes a beneficial connection between wellness practices, healthcare outcomes, insurance costs, reimbursements, and employee productivity. This connection can be demonstrated more effectively with large sets of data that connect wellness practices to health outcomes across large populations. Establishment of this connection can help to justify the reimbursements and other incentives offered by a participating payer 104, and a decrease in premiums offered by an insurer 106.

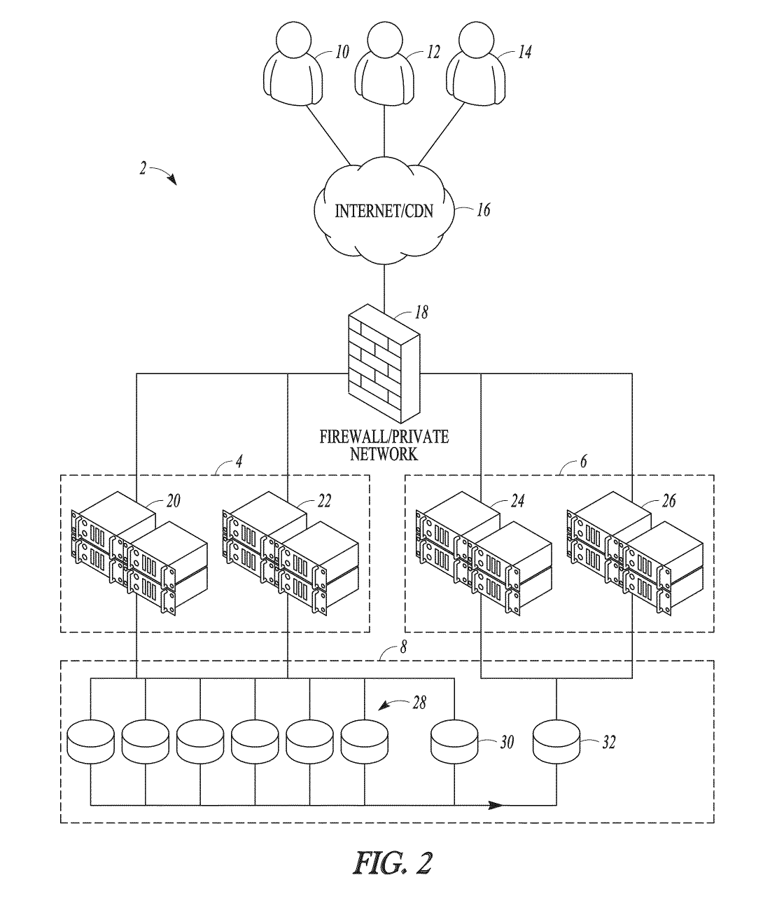

An overview of the architecture and functioning of system software enabling the wellness program 100 is now provided with reference to FIG. 2 of the accompanying drawings.

The software indicated generally by numeral 2 can be viewed as comprising three primary components, namely a Software as a Service (SaaS) business management software solution (generally by box 4 in dotted outline), a finder software solution (generally indicated by box 6 in dotted outline), and associated databases (generally indicated by box 8 in dotted outline). The software 2 can be marketed and its functionality presented to health and wellness industries, including the entities 102-108 shown in FIG. 1. The software 2 provides a web-based business management software platform to clients including, for example, fitness, yoga, Pilates, dance, salon, spa and martial arts businesses. The clients can thus include the “wellness providers” 102 shown in FIG. 1 and the “participating providers” mentioned in the definitions just above. The software can also be presented and marketed to client entities such as employers, individuals and government agencies which might be willing to pay for a portion of the services of wellness providers as part of an employee wellness or incentive program, for example. These client entities can thus include the “employers” 104 shown in FIG. 1 and the “participating payers” also mentioned in the definitions just above. These client groups can use the software 2 to support various aspects of their businesses, including scheduling and e-commerce capabilities, staff and customer management, and retail point of sale (POS).

The business management software 4 may in turn be viewed as having two subcomponents, namely business management software UI software 20 and core API software 22, which reside on respective servers and are accessible via respective URLs (for example, clients.mindbodyonline.com and API.mindbodyonline.com).

The business management software user interface (UI) component 20 has two core modes of operation, namely a “business mode” and a “consumer mode”, and provides corresponding business mode and consumer mode user interfaces. The business mode interfaces are accessible to business mode users 10 via the Internet (or a CDN) 16 and firewall/private network 18. The business mode interfaces provide business mode users 10 (for example, owners, managers, and staff at clients) with front and back office functionality for performing and managing core operations of their businesses. The business mode users can include the clients mentioned above i.e. the employers/participating payers 104 and the wellness providers/participating providers 102.

The consumer mode interfaces provide customer mode users 12 (e.g., customers of the clients or subscribers of the software) with online access to the software 2 in order to manage their accounts, payments and schedules. Customer mode users can include the consumers 106 shown in FIG. 1 and the “covered individuals” mentioned in the definitions above.

In addition to the business mode and consumer mode user interfaces, the software 2, and specifically the core API software 22, provides application programming interfaces (APIs) that are consumed by business partners, and other third parties, to provide complementary, value-added software and services, including mobile applications, custom reporting, and integrations with other hardware and software vendors.

The finder software 6 includes finder portal user interface (UI) software 24, and finder API software 26. The finder software 6 is accessible by finder users 14 via the Internet 16 and firewall 18. Finder users may include employers 104 (participating payers), wellness providers 102 (participating providers), consumers 106 (covered individuals), insurers 108 (participating insurers) and other third parties. The finder software 6 provides an aggregation service to consumer portals and mobile applications, so that all software clients (or subscribers), wellness classes, appointment or reservation offerings can be searched and booked. As with the business management software 4, the finder software 6 is accessible via a web portal (www.mindbodyfinder.com) and APIs.

Turning now to the backend, the databases 8 include multiple subscriber databases 28, system databases 30, and an aggregate database 32. The databases 8 are analogous to the data warehouse 110 shown in FIG. 1. The databases 8 are architected to use shards (as opposed to horizontal partitioning), whereby each client or subscriber (employer, consumer or wellness provider) is issued with their own logical instance of a subscriber database 28. A sharded architecture promotes high-availability, faster queries, and scalability for rapid growth environments. When a database server reaches full capacity, new SQL instances are brought online and the databases are distributed across instances to load balance.

The system databases 30 store master client records (MCRs), which use identification tags and email addresses to identify individual clients across all of the subscriber databases 28. The MCRs are copied to the aggregate database 32 as part of an aggregate refresh process. Further, the MCRs are used by the finder software 6 to confirm the existence of clients, and to prevent the duplication of client records in the subscriber databases 28.

The subscriber databases 28 are aggregated, via an aggregate process, to the aggregate database 32. The aggregation process is a once-per-day operation that extracts basic business information (e.g., names, addresses etc.), class/appointment schedule information and appointment service offering information from the respective subscriber databases 28. This extracted information is then combined and indexed into the aggregate database 28. It is important to note that real-time class or appointment information is not aggregated into the aggregate database 32—aggregation is only performed once every 24 hours, and typically at night. This is turn requires that, when performing a class or appointment booking, the software 2 performs a real-time validation on the subscriber databases 28. Bookings are then recorded in both the aggregate database 32, as well as the relevant subscriber database 28, in real-time (or near real-time).

Regarding queries run against the databases 8, for classes, finder queries are run by the finder software 6 against the aggregate database 32, which includes business and location information, staff biographies, class descriptions and scheduled class times. For appointments, finder queries are run by the finder software 6 against the aggregate database 32 for business information, location information and appointment service type information only. The finder software 6 runs separate queries against the subscriber databases 28 for staff information (e.g., who offers a particular type of appointment) and real-time appointment availability.

FIGS. 3A-3G illustrate some example screenshots that can be presented in one or more of the interfaces described above. The interfaces can be presented in a computer monitor or mobile device, for example. The screenshots depict example aspects of the wellness program 100 that facilitate execution of the program for participating entities such as the employers 104, the wellness providers 102, the consumers 106, the insurers 108, and third parties. These entities are generally referred to as “users” in the description just below.

For example, in FIG. 3A an example banner bar 132 presents drop-down menus relating to program features, pricing, Add-Ons, education, clients, company and Buy Now. FIG. 3B presents example interfaces for on-line sales and scheduling 134 (e.g. for making on-line reservations and on-line appointments), staff and resource scheduling 136 and point of sale 138 applications. FIG. 3C depicts example interfaces for day-to-day automation 140, business analytics (e.g. ROI analysis) 142, and customer relationship and marketing tools 144. FIG. 3D shows an example finder interface that allows a user to search for wellness classes, for example “yoga” entered or chosen at user-interface element 146, which are located at or nearby a geo-location of the user as depicted for example by the ZIP code “30004” entered in user-interface element 148. A list of such services (for example, yoga classes) offered by wellness providers is shown at elements 150, for example. Details of the dates, times and prices of classes can be given in the banners 152, for example, as well as details of the specific type of yoga class being offered (“Bikram 60”, for example). A user clicking on one of the wellness providers listed in the interface shown in FIG. 3D can be shown an interface depicted in FIG. 3E, for example. This view depicts further wellness classes, appointments times, prices and so forth 154 offered by the selected wellness provider, as well as a map 156 indicating the geo-location of the wellness provider. FIG. 3F depicts an interface in which a global map of the world is represented. The general geo-locations of wellness providers within given countries are indicated by balloons 158 in the view. A user can enter as a search query a city, state or zip code in user-interface element 160, for example and, in response to such entry, a more detailed view of the geo-locations of wellness providers within a selected city (San Francisco, in this example) can be provided in the interface as shown in FIG. 3G, for example. The geo-locations of wellness providers are represented by dots or bubbles 162 on the displayed map and further details, classes, maps and so forth can be provided in separate views in similar fashion manner to the interface of FIG. 3E.

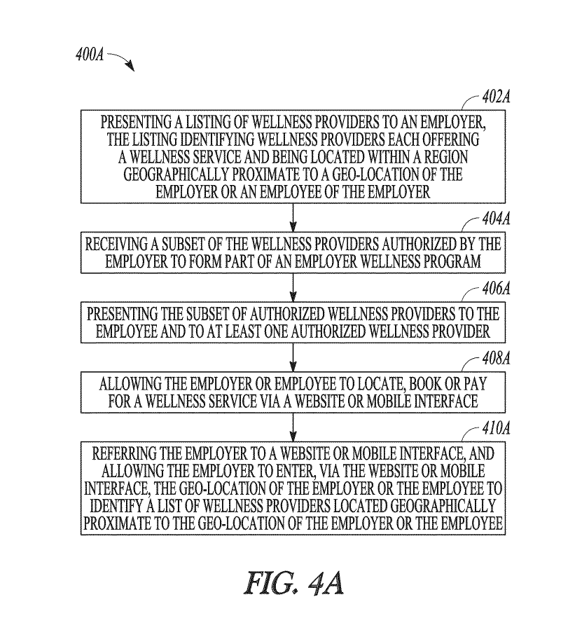

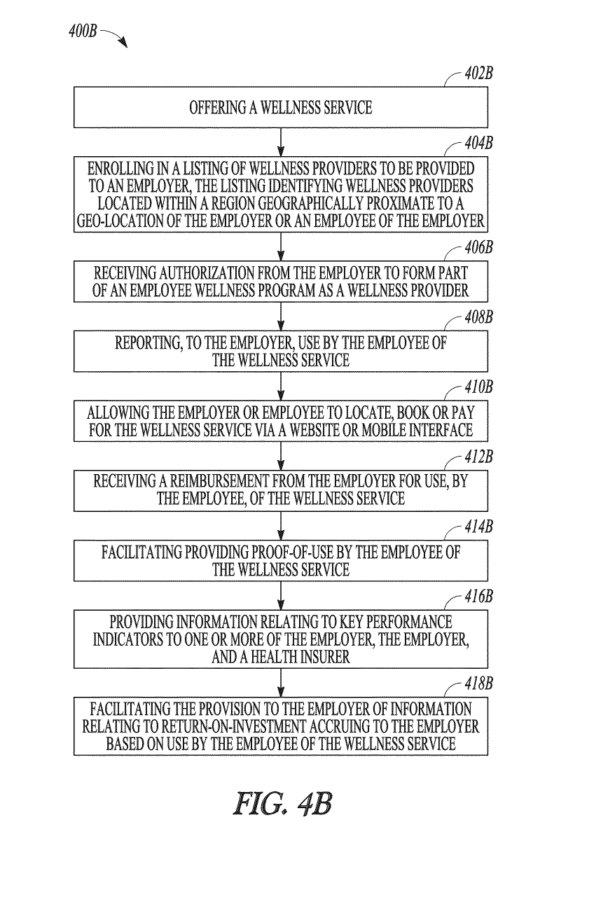

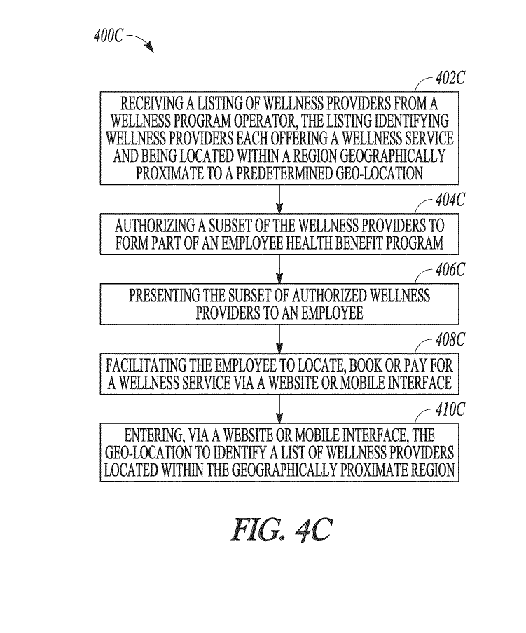

FIGS. 4A-4C illustrate example methods relating to some aspects of a wellness program 100. Some portions of the method may be performed by processing logic that may comprise hardware (e.g., dedicated logic, programmable logic, microcode, etc.), software (such as that which may be run on a general-purpose computer system or a dedicated machine), or a combination of both. Some portions of the methods may be performed by various modules in an example computer system 500 (described further below) that may be used as part of the systems and methods described herein. Each of these modules may comprise processors and processing logic.

As shown in FIG. 4A, a method 400A for a wellness program comprises: at operation 402A, presenting a listing of wellness providers to an employer, the listing identifying wellness providers each offering a wellness service and being located within a region geographically proximate to a geo-location of the employer or an employee of the employer; at 404A, receiving a subset of the wellness providers authorized by the employer to form part of an employer wellness program; and, at 406A, presenting the subset of authorized wellness providers to the employee and to at least one authorized wellness provider. The wellness program may include incentives for use by the employee of the wellness service provided by one or more of the authorized wellness providers.

The method 400A may further comprise at 408A allowing the employer or employee to locate, book or pay for a wellness service via a website or mobile interface. Presenting a listing of wellness providers to an employer may include, at 410A, referring the employer to a website or mobile interface, and allowing the employer to enter, via the website or mobile interface, the geo-location of the employer or the employee to identify a list of wellness providers located geographically proximate to the geo-location of the employer or the employee.

In some examples, the method 400A may further comprise facilitating a reporting by one or more of the authorized wellness providers, to the employer, of the use by the employee of the relevant wellness service. The method my still further comprise facilitating a reimbursement made by the employer, to one or more of the authorized wellness providers, for use by the employee of the relevant wellness service.

In some examples, the method 400A may further comprise facilitating providing proof-of-participation by the employee in the wellness program to a health insurer. In some examples, the method 400A further comprises facilitating receipt by the employer of an incentive or reimbursement made by the health insurer as part consideration for participation by the employee in the wellness program. In some examples, the method 400A further comprises providing, to the employer or the employee, key performance indicators relating to the wellness service provided by one or more of the authorized wellness providers. In some examples, the method 400A further comprises providing, to the employer, information relating to return-on-investment accruing to the employer based on participation by the employee in the wellness program.

As shown in FIG. 4B, a method 400B for a wellness program comprises: at operation 402B, offering a wellness service; at operation 404B, enrolling in a listing of wellness providers to be provided to an employer, the listing identifying wellness providers located within a region geographically proximate to a geo-location of the employer or an employee of the employer; at 406B, receiving authorization from the employer to form part of an employee wellness program as a wellness provider; and at 408B, reporting, to the employer, use by the employee of the wellness service.

The method 400B may further comprise at 410B allowing the employer or employee to locate, book or pay for the wellness service via a website or mobile interface. In some examples, the method 400B further comprises at 412B receiving a reimbursement from the employer for use, by the employee, of the wellness service. In some examples, the method 400B further comprises at 414B facilitating providing proof-of-use by the employee of the wellness service.

In some examples, the method 400B further comprises at 416B providing information relating to key performance indicators to one or more of the employer, the employer, and a health insurer. In some examples, the method 400B further comprises at 418B facilitating the provision to the employer of information relating to return-on-investment accruing to the employer based on use by the employee of the wellness service.

As shown in FIG. 4C, a method 400C for a wellness program comprises: at operation 402C, receiving a listing of wellness providers from a wellness program operator, the listing identifying wellness providers each offering a wellness service and being located within a region geographically proximate to a predetermined geo-location; at 404C, authorizing a subset of the wellness providers to form part of an employee health benefit program; and at 406C, presenting the subset of authorized wellness providers to an employee. The health benefit program includes incentives for use by the employee of the wellness service provided by one or more of the authorized wellness providers.

The method 400C may further comprise at 408C facilitating the employee to locate, book or pay for a wellness service via a website or mobile interface. In some examples, the method 400C further comprises at 410C entering, via a website or mobile interface, the geo-location to identify a list of wellness providers located within the geographically proximate region.

In some examples, the method 400C further comprises receiving a reporting from one or more of the authorized wellness providers relating to the use by the employee of the relevant wellness service. In some examples, the method 400C further comprises making a reimbursement to one or more of the authorized wellness providers for use by the employee of the relevant wellness service. In some examples, the method 400C further comprises providing proof-of-participation by the employee in the health benefit program to a health insurer. In some examples, the method 400C further comprises receiving an incentive or reimbursement from the health insurer as part consideration for participation by the employee in the health benefit program.

In some examples, the method 400C further comprises receiving information relating to key performance indicators of the wellness service provided by one or more of the authorized wellness providers. In some examples, the method 400C further comprises receiving information relating to return-on-investment based on participation by the employee in the health benefit program.

FIG. 5 illustrates an example computer system 500 that may be used as part of the systems and methods described herein. The example computer system 500 includes a processor or multiple processors 502 (e.g., a central processing unit (CPU), a graphics processing unit (GPU), or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 may also include an alphanumeric input device 512 (e.g., a keyboard), a cursor control device 514 (e.g., a mouse), a disk drive unit 516, a signal generation device 518 (e.g., a speaker) and a network interface device 520.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice.

Thus, systems and methods for wellness programs have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A method comprising:
receiving a listing of wellness providers from a wellness program operator, the listing identifying wellness providers each offering a wellness service and being located within a region geographically proximate to a predetermined geo-location;
authorizing a subset of the wellness providers to form part of an employee health benefit program; and
presenting the subset of authorized wellness providers to an employee.

2. The method of claim 1, wherein the health benefit program includes incentives for use by the employee of the wellness service provided by one or more of the authorized wellness providers.

3. The method of claim 1, further comprising facilitating the employee to locate, book or pay for a wellness service via a website or mobile interface.

4. The method of claim 1, further comprising entering, via a website or mobile interface, the geo-location to identify a list of wellness providers located within the geographically proximate region.

5. The method of claim 1, further comprising receiving a reporting from one or more of the authorized wellness providers relating to the use by the employee of the relevant wellness service.

6. The method of claim 1, further comprising making a reimbursement to one or more of the authorized wellness providers for use by the employee of the relevant wellness service.

7. The method of claim 1, further comprising providing proof-of-participation by the employee in the health benefit program to a health insurer.

8. The method of claim 7, further comprising receiving an incentive or reimbursement from the health insurer as part consideration for participation by the employee in the health benefit program.

9. The method of claim 1, further comprising receiving information relating to key performance indicators of the wellness service provided by one or more of the authorized wellness providers.

10. The method of claim 1, further comprising receiving information relating to return-on-investment based on participation by the employee in the health benefit program.

11. A system comprising:
at least one module, executing on one or more computer processors, to:
present a listing of wellness providers to an employer, the listing identifying wellness providers located within a region geographically proximate to a geo-location of the employer, or an employee of the employer;
receive a subset of the wellness providers authorized by the employer to form part of an employer wellness program, the wellness program including incentives for employee use of a service provided by one or more of the authorized wellness providers; and
present the subset of authorized wellness providers to employees and to at least one authorized wellness provider.

12. The system of claim 11, wherein the health benefit program includes incentives for use by the employee of the wellness service provided by one or more of the authorized wellness providers.

13. The system of claim 11, wherein the at least one module is further to facilitate the employee to locate, book or pay for a wellness service via a website or mobile interface.

14. The system of claim 11, wherein the at least one module is further to facilitate entry, via a website or mobile interface, of the geo-location to identify a list of wellness providers located within the geographically proximate region.

15. The system of claim 11, wherein the at least one module is further to receive a reporting from one or more of the authorized wellness providers relating to the use by the employee of the relevant wellness service.

16. The system of claim 11, wherein the at least one module is further to make a reimbursement to one or more of the authorized wellness providers for use by the employee of the relevant wellness service.

17. The system of claim 11, wherein the at least one module is further to provide proof-of-participation by the employee in the health benefit program to a health insurer.

18. The system of claim 11, wherein the at least one module is further to receive an incentive or reimbursement from the health insurer as part consideration for participation by the employee in the health benefit program.

19. The system of claim 11, wherein the at least one module is further to receive information relating to key performance indicators of the wellness service provided by one or more of the authorized wellness providers.

20. The system of claim 11, wherein the at least one module is further to receive information relating to return-on-investment based on participation by the employee in the health benefit program.

21. A machine readable medium, including instructions, which when performed by a machine, cause the machine to perform the operations of:
presenting a listing of wellness providers to an employer, the listing identifying wellness providers located within a region geographically proximate to a geo-location of the employer, or of an employee of the employer;
receiving a subset of the wellness providers authorized by the employer to form part of an employer wellness program, the wellness program including incentives for employee use of a service provided by one or more of the authorized wellness providers; and
presenting the subset of authorized wellness providers to employees and to at least one authorized wellness provider.

22. The medium of claim 21, wherein the health benefit program includes incentives for use by the employee of the wellness service provided by one or more of the authorized wellness providers.

23. The medium of claim 21, wherein the operations further comprise facilitating the employee to locate, book or pay for a wellness service via a website or mobile interface.

24. The medium of claim 21, wherein the operations further comprise entering, via a website or mobile interface, the geo-location to identify a list of wellness providers located within the geographically proximate region.

25. The medium of claim 21, wherein the operations further comprise receiving a reporting from one or more of the authorized wellness providers relating to the use by the employee of the relevant wellness service.

26. The medium of claim 21, wherein the operations further comprise making a reimbursement to one or more of the authorized wellness providers for use by the employee of the relevant wellness service.

27. The medium of claim 21, wherein the operations further comprise providing proof-of-participation by the employee in the health benefit program to a health insurer.

28. The medium of claim 27, wherein the operations further comprise receiving an incentive or reimbursement from the health insurer as part consideration for participation by the employee in the health benefit program.

29. The medium of claim 21, wherein the operations further comprise receiving information relating to key performance indicators of the wellness service provided by one or more of the authorized wellness providers.

30. The medium of claim 21, wherein the operations further comprise receiving information relating to return-on-investment based on participation by the employee in the health benefit program.
